(19) United States
(12) Patent Application Publication
(10) Pub. No.: US 2009/0152412 A1
(43) Pub. Date: Jun. 18, 2009

(54) INSTRUMENT STAND

(76) Inventors: Michael L. Lorenz, Toledo, OH (US); Javier Barrios, Wixom, MI (US)

Correspondence Address: FRASER CLEMENS MARTIN & MILLER LLC, 28366 KENSINGTON LANE, PERRYSBURG, OH, 43551, US

(21) Appl. No.: 12/391,401

(22) Filed: Feb. 24, 2009

Related U.S. Application Data
(63) Continuation-in-part of application No. 11/748,133, filed on May 14, 2007.

(51) Int. Cl. F16M 11/24; F16M 11/04

(52) U.S. Cl. 248/165; 248/176.3

(57) ABSTRACT

A stand for musical instruments is disclosed, wherein the stand may be quickly and easily set up to provide a stable platform for supporting instruments and components used therewith and may also be quickly and easily collapsed for transport or storage.

### CROSS-REFERENCE TO RELATED APPLICATIONS

This application is a continuation-in-part application of U.S. patent application Ser. No. 11/748,133 INSTRUMENT STAND filed on May 14, 2007, hereby incorporated herein by reference in its entirety.

### FIELD OF THE INVENTION

The invention relates generally to a stand and more particularly to a stand for musical instruments which provides a stable platform for supporting instruments and components used therewith.

### BACKGROUND OF THE INVENTION

Musicians often use a stand or support to support a musical instrument, such as a keyboard, for example, in a desired position. Since musical equipment is often set up and then taken down within a short period of time, it is desirable that the stand be capable of being set up in a minimal amount of time, and without the need for special tools or skills. Once the stand is set up, it must be stable to securely support the musical instrument. Additionally, it is desirable that the stand be collapsible into a small and lightweight package to facilitate transportation and storage between uses thereof.

Prior art musical instrument stands can be time consuming and/or difficult to set up and may require the use of special tools or skills. Further, prior art musical instrument stands may provide inadequate support and may be bulky and unadjustable, thereby preventing the instruments supported thereon from being positioned as desired.

It would also be desirable to produce a stand for a musical instrument which may be quickly and easily set up for use and quickly and easily collapsed for transport or storage, wherein a cost, a weight, and a size when collapsed are minimized, and an adjustability thereof is maximized.

### SUMMARY OF THE INVENTION

Concordant and consistent with the present invention, a stand for a musical instrument which may be quickly and easily set up for use and quickly and easily collapsed for transport or storage, wherein a cost, a weight, and a size when collapsed are minimized, and an adjustability thereof is maximized, has surprisingly been discovered.

In one embodiment, a collapsible stand for supporting an instrument comprises: a first section including a first instrument supporting shelf; a second section including a second instrument supporting shelf and hingedly coupled to the first section, wherein the first instrument supporting shelf and the second instrument supporting shelf cooperate to support a first instrument; a utility cross bar coupled to the first instrument supporting shelf and the second instrument supporting shelf, wherein the utility cross bar includes a plurality of through holes for receiving and securing an accessory device to the utility cross bar.

In another embodiment, a collapsible stand for supporting an instrument comprises: a first section including a first supporting structure, the first supporting structure including a first instrument supporting shelf; a second section hingedly coupled to the first section and including a second supporting structure, the second supporting structure including a second instrument supporting shelf, wherein the first instrument supporting shelf and the second instrument supporting shelf cooperate to support a first instrument; and an equipment caddy disposed on the first supporting structure and the second supporting structure, wherein the equipment caddy is adjusted to secure and transport equipment of various sizes and shapes.

In another embodiment, a collapsible stand for supporting an instrument comprises: a first section including a first supporting structure, the first supporting structure including a first instrument supporting shelf; a second section hingedly coupled to the first section and including a second supporting structure, the second supporting structure including a second instrument supporting shelf, wherein the first instrument supporting shelf and the second instrument supporting shelf cooperate to support a first instrument; and a removable storage shelf disposed on the first supporting structure and the second supporting structure.

### BRIEF DESCRIPTION OF THE DRAWINGS

The above, as well as other objects and advantages of the present invention will become readily apparent to one skilled in the art from reading the following detailed description of a preferred embodiment of the invention when considered in the light of the accompanying drawings, in which:

FIG. 1 is a perspective view of an instrument stand in a set up position in accordance with an embodiment of the invention;

FIG. 2 is a perspective view of the instrument stand illustrated in FIG. 1 shown in a collapsed position;

FIG. 3 is a perspective view of an instrument stand in a set up position in accordance with another embodiment of the invention;

FIG. 4 is a perspective view of an instrument stand in a set up position in accordance with another embodiment of the invention;

FIG. 5 is a perspective view of the instrument stand of FIG. 4 including a storage shelf;

FIG. 6 is a perspective view of the instrument stand of FIG. 4 including an equipment caddy; and

FIG. 7 is a top elevational view of the equipment caddy of FIG. 6.

### DETAILED DESCRIPTION OF THE PREFERRED EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

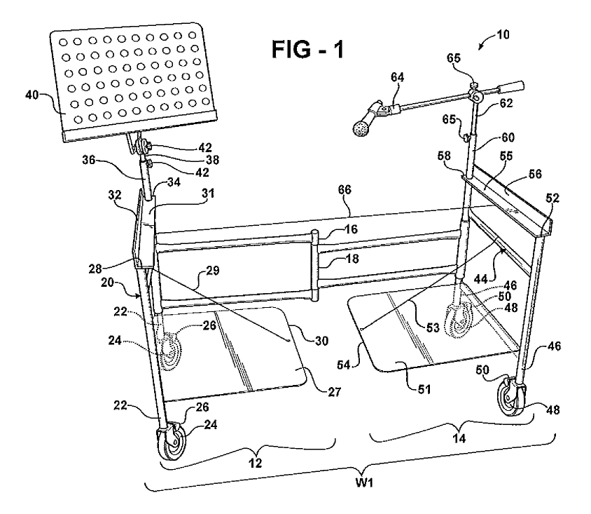

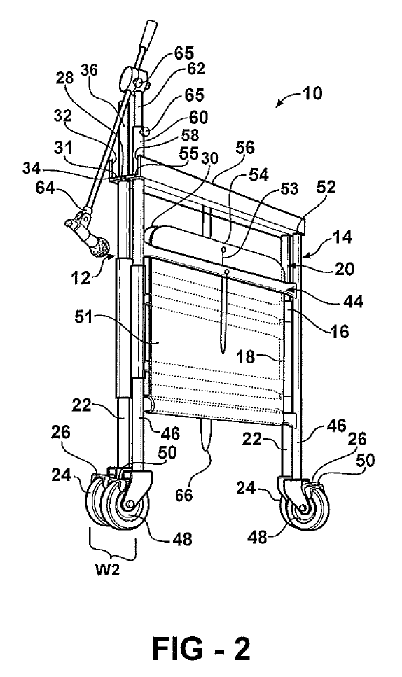

Referring to FIGS. 1 and 2 of the drawings, there is shown an instrument stand 10. The stand 10 is adapted to support a musical instrument (not shown) such as a keyboard, for example. It is understood that the stand 10 may support other items as desired. In the embodiment shown, the stand 10 is formed from a metal such as aluminum. It is understood that other materials may be used to form the stand 10 without departing from the scope and spirit of the invention. The stand 10 includes a first section 12 hingedly coupled to a second section 14. In the embodiment shown, the first section 12 includes a male member 16 that is received by a corresponding hollow female member 18 of the second section 14. However, it is understood that the first section 12 can be hingedly coupled to the second section 14 by any means as desired.

The first section 12 includes a first supporting structure 20 hingedly connected thereto. The first supporting structure 20 includes a pair of spaced apart first tubular members 22. Each of the first tubular members 22 includes a ground engaging wheel 24 pivotally disposed thereon. The wheels 24 each include locking structure 26 to selectably permit and militate against a rotation of the wheel 24.

The first supporting structure 20 includes a first equipment supporting shelf 27 hingedly disposed thereon. When in a set up position, as illustrated in FIG. 1, the first equipment supporting shelf 27 is substantially horizontal and extends toward the second section 14. When in a transporting and storage position, as illustrated in FIG. 2, the first equipment supporting shelf 27 is substantially vertical and extends upwardly toward a top portion 28 of the first supporting structure 20. A first flexible member 29 is disposed between a first end 30 of the first equipment supporting shelf 27 and the first supporting structure 20. In the embodiment shown, the first flexible member 29 is a cable. However, it is understood that other flexible members 29 can be used such as a wire, a string, a strap, or a linkage, for example.

The top portion 28 of the first supporting structure 20 includes a first instrument supporting shelf 31 thereon. It is understood that the first instrument supporting shelf 31 can be disposed elsewhere on the first supporting structure 20 as desired, such as at a position intermediate the first equipment supporting shelf 27 and the top portion 28 thereof, for example. The first instrument supporting shelf 31 includes a laterally upwardly extending lip 32.

A first end 34 of the first instrument supporting shelf 31 includes a second tubular member 36 extending therefrom. In the embodiment shown, one of the first tubular members 22 is formed integrally with the second tubular member 36. It is understood that the tubular members 22, 36 can be formed separately if desired. The second tubular member 36 is adapted to receive a third tubular member 38 coupled to a bookstand 40. It is understood that the second tubular member 36 can receive other structures as desired without departing from the scope and spirit of the invention. Threaded securing devices 42 are disposed in apertures (not shown) formed in the tubular members 36, 38 to facilitate selective positioning of the bookstand 40 or other accessory. It is understood that the third tubular member 38 and the bookstand 40 can be removed from the stand 10 as desired, as shown in FIG. 2.

The second section 14 includes a second supporting structure 44 hingedly connected thereto. The second supporting structure 44 includes a pair of spaced apart fourth tubular members 46. Each of the tubular members 46 includes a wheel 48 pivotally disposed therein. The wheels 48 each include locking structure 50 to selectably permit and militate against a rotation of the wheel 48.

The second supporting structure 44 includes a second equipment supporting shelf 51 hingedly disposed thereon. When in a set up position, as illustrated in FIG. 1, the second equipment supporting shelf 51 is substantially horizontal and extends toward the first section 12. When in a transporting and storage position, as illustrated in FIG. 2, the second equipment supporting shelf 51 is substantially vertical and extends upwardly toward a top portion 52 of the second supporting structure 44. A second flexible member 53 is disposed between a first end 54 of the second equipment supporting shelf 51 and the second supporting structure 44. In the embodiment shown, the second flexible member 53 is a cable. However, it is understood that other flexible members 53 can be used such as a wire, a string, a strap, or a linkage, for example.

The top portion 52 of the second supporting structure 44 includes a second instrument supporting shelf 55 disposed thereon. It is understood that the second instrument supporting shelf 55 can be disposed elsewhere on the second supporting structure 44 as desired, such as at a position intermediate the second equipment supporting shelf 51 and the top portion 52 thereof, for example. The second supporting shelf 55 includes a laterally upwardly extending lip 56.

A first end 58 of the second instrument supporting shelf 55 includes a fifth tubular member 60 extending therefrom. In the embodiment shown, one of the fourth tubular members 46 is formed integrally with the fifth tubular member 60. It is understood that the tubular members 46, 50 can be formed separately if desired. The fifth tubular member 60 is adapted to receive a sixth tubular member 62 that is coupled to a microphone supporting device 64. The fifth tubular member 60 can receive other structures without departing from the scope and spirit of the invention. Threaded securing devices 65 are disposed in apertures (not shown) formed in the tubular members 60, 62. It is understood that the sixth tubular member 62 and the microphone supporting device 64 can be removed from the stand 10 if desired.

In the embodiment shown, a third flexible member 66, such as a wire, for example, is disposed between the first supporting structure 20 and the second supporting structure 44. When in a set up position as illustrated in FIG. 1, the flexible member 66 is in an extended position. When in a transporting and storage position as illustrated in FIG. 2, the flexible member 66 is in a relaxed position.

In use, the stand 10 is converted to the set up position illustrated in FIG. 1 from the transporting and storage position as illustrated in FIG. 2. To convert the stand, the first supporting structure 20 and the second supporting structure 44 are grasped by a user (not shown) and pulled apart from each other so the first section 12 and the second section 14 form a substantially U-shaped structure. Optionally, the sections 12, 14 and the member 66 may be extensible to facilitate a width W adjustment of the stand 10. It is understood that the extensibility may be facilitated by any means as desired, such as wherein at least one of the sections 12, 14 includes a telescoping section (not shown), or such as the front leg disclosed in U.S. Pat. No. 5,449,247 hereby incorporated herein by reference in its entirety. Additionally, the tubular members 22, 46 of the supporting structures 20, 44 may be extensible to facilitate a height H adjustment of the stand 10. It is understood that the extensibility may be facilitated by any means as desired, such as wherein the supporting structures 20, 44 include a telescoping section (not shown), or such as the front leg disclosed in U.S. Pat. No. 5,449,247, for example.

The first equipment supporting shelf 27 is rotated toward the second supporting structure 44 to place the first flexible member 29 in an extended position as shown in FIG. 1. The second equipment supporting shelf 51 is rotated toward the first supporting structure 20 to place the second flexible member 53 in an extended position as shown in FIG. 1. It is understood that the equipment supporting shelves 27, 51 can be replaced or supplemented with a single equipment holding shelf (not shown) as desired. The single equipment holding shelf could be attached to the stand 10 by any means, such as with a clamp or a clip, for example. It is also understood that the flexible members 29, 53 could be removed from the stand 10 as desired and replaced with a clip or hook, for example (not shown) disposed on the equipment supporting shelves 27, 51. The clip or hook disposed on the equipment supporting shelves 27, 51 could be fasten to the first section 12 and the second section 14, respectively, when the stand 10 is in a set up position to militate against a rotation thereof. The stand 10 can then be moved into a desired position and the wheels 24, 48 can be locked using the locking structures 26, 50.

The third tubular member 38 that is coupled to the bookstand 40 is disposed in the second tubular member 36. The bookstand 40 may be selectively secured in place with by rotating the securing devices 42. The sixth tubular member 62 coupled to the microphone supporting device 64 is disposed in the fifth tubular member 60. The microphone supporting device 64 may be selectively secured in place by rotating the securing devices 65.

Once in the set up position, the musical instrument is disposed on the instrument supporting shelves 31, 55. The lips 32, 56 militate against relative lateral movement between the stand 10 and the musical instrument. The bookstand 40 and microphone supporting device 64 can easily be reached and positioned by the user for use. The equipment supporting shelves 27, 51 can be used to support additional equipment (not shown) such as foot pedals or electrical wiring, for example.

After use, the musical instrument and additional equipment is removed from the stand 10. The stand 10 can then be collapsed by reversing the set up procedure previously described herein. In the embodiment shown, the stand 10 has a width W2 of approximately seven inches in the collapsed position and can be quickly and easily transported and stored in a desired location. It is understood that the width W2 can be larger or smaller as desired.

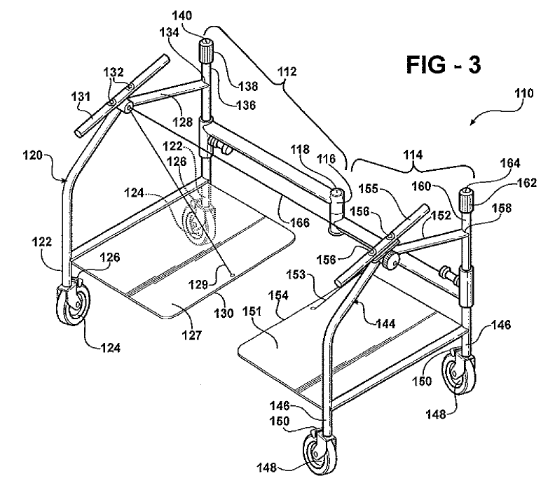

FIG. 3 shows an instrument stand 110. The stand 110 is adapted to support a first musical instrument (not shown) such as a keyboard, for example. It is understood that the stand 110 may support other items as desired. In the embodiment shown, the stand 110 is formed from a metal such as aluminum. It is understood that other materials may be used to form the stand 110 without departing from the scope and spirit of the invention. The stand 110 includes a first section 112 hingedly coupled to a second section 114. In the embodiment shown, the first section 112 includes a hollow female member 116 that receives a corresponding male member 118 of the second section 114. However, it is understood that the first section 112 can be hingedly coupled to the second section 114 by any means as desired.

The first section 112 includes a first supporting structure 120 hingedly connected thereto. The first supporting structure 120 includes a pair of spaced apart first tubular members 122. Each of the first tubular members 122 includes a ground engaging wheel 124 pivotally disposed therein. The wheels 124 each include locking structure 126 to selectably permit and militate against a rotation of the wheel 124.

The first supporting structure 120 includes a first equipment supporting shelf 127 hingedly disposed thereon. When in a set up position, as illustrated in FIG. 3, the first equipment supporting shelf 127 is substantially horizontal and extends toward the second section 114. When in a transporting and storage position (not shown), the first equipment supporting shelf 127 is substantially vertical and extends upwardly toward a top portion 128 of the first supporting structure 120. A first flexible member 129 is disposed between a first end 130 of the first equipment supporting shelf 127 and the first supporting structure 120. In the embodiment shown, the first flexible member 129 is a cable. However, it is understood that other flexible members 29 can be used such as a wire, a string, a strap, or a linkage, for example.

The top portion 128 of the first supporting structure 120 includes a first instrument supporting shelf 131 pivotally disposed thereon. The first supporting shelf 131 includes a plurality of apertures 132 formed therein for receiving corresponding structure (not shown) disposed on the musical instrument.

A first end 134 of the top portion 128 of the first supporting structure 120 includes a second tubular member 136 extending therefrom. In the embodiment shown, the second tubular member 136 is formed integrally with one of the first tubular members 122. However, it is understood that the tubular members 122, 136 can be formed separately if desired. The first tubular member 136 includes an end cap 138 having an aperture 140 formed in a distal end thereof. The aperture 140 is adapted to receive a third tubular member (not shown) coupled to a first piece of equipment (not shown) such as a bookstand, for example. It is understood that the aperture 140 can receive other structures as desired.

The second section 114 includes a second supporting structure 144 hingedly connected thereto. The second supporting structure 144 includes a pair of spaced apart fourth tubular members 146. Each of the fourth tubular members 146 includes a wheel 148 pivotally disposed therein. The wheels 148 each include locking structure 150 to selectably permit and militate against a rotation of the wheel 148.

The second supporting structure 144 includes a second equipment supporting shelf 151 hingedly disposed thereon. When in a set up position, as illustrated in FIG. 3, the second equipment supporting shelf 151 is substantially horizontal and extends toward the first section 112. When in a transporting and storage position (not shown), the second equipment supporting shelf 151 is substantially vertical and extends upwardly toward a top portion 152 of the second supporting structure 144. A second flexible member 153 is disposed between a first end 154 of the second equipment supporting shelf 151 and the second supporting structure 144. In the embodiment shown, the second flexible member 153 is a cable. However, it is understood that other flexible members 153 can be used such as a wire, a string, a strap, or a linkage, for example.

The top portion 152 of the second supporting structure 144 includes a second instrument supporting shelf 155 pivotally disposed thereon. The second supporting shelf 155 includes a plurality of apertures 156 formed therein for receiving corresponding structure (not shown) disposed on the musical instrument.

A first end 158 of the top portion 152 of the second supporting structure 144 includes a fifth tubular member 160 extending therefrom. The fifth tubular member 160 includes an end cap 162 having an aperture 164 formed in a distal end thereof. The aperture 164 is adapted to receive a sixth tubular member (not shown) coupled to a second piece of equipment (not shown) such as a microphone supporting device, for example. It is understood that the aperture 164 can receive other structures as desired.

In the embodiment shown, the stand 110 includes a third instrument supporting shelf 168 and a fourth instrument supporting shelf 170 disposed thereon. The third instrument supporting shelf 168 includes a seventh tubular member 172 coupled to the first instrument supporting shelf 131 and an eighth tubular member 174 hingedly coupled to the seventh tubular member 172. A first end (not shown) of a second musical instrument (not shown), such as a keyboard, for example, can be mounted on the eighth tubular member 174. The fourth instrument supporting shelf 170 includes a ninth tubular member 176 coupled to the second instrument supporting shelf 155 and a tenth tubular member 178 hingedly coupled to the ninth tubular member 176. A second end (not shown) of the second instrument can be mounted on the tenth tubular member 178. While the instrument supporting shelves 131, 155, 168, 170 have been shown as arranged in a tiered arrangement, other arrangements can be used as desired, such as a front/back arrangement, for example.

In the embodiment shown, a third flexible member 166, such as a wire, for example, is disposed between the first supporting structure 120 and the second supporting structure 144. When in a set up position as illustrated in FIG. 3, the flexible member 166 is in an extended position. When in a transporting and storage position the flexible member 166 is in a relaxed position.

Use of the stand 110 is substantially the same as the stand 10 illustrated in FIGS. 1 and 2 and described above. However, the first musical instrument is disposed on the stand 110 by disposing the corresponding structure disposed on the musical instrument into the apertures 132, 156 formed in the instrument supporting shelves 131, 155. The second musical instrument is mounted to the instrument supporting shelves 168, 170 by any conventional means, such as with the use of straps (not shown), for example. Since the instrument supporting shelves 131, 155, are pivotally disposed on the supporting structure 120, 144, the first musical instrument can be rotated by a user (not shown) into a desired position. Additionally, since the instrument supporting shelves 168, 170, are pivotally disposed on the instrument supporting shelves 131, 155, the second musical instrument can be rotated by the user into a desired position.

While the instrument supporting shelves 131, 155, 168, 170 have been shown as being shorter in length than the supporting structures 120, 144, it is understood that the instrument supporting shelves 131, 155, 168, 170 can be as long as or longer in length than the supporting structures 120, 144 as desired without departing from the scope and spirit of the invention.

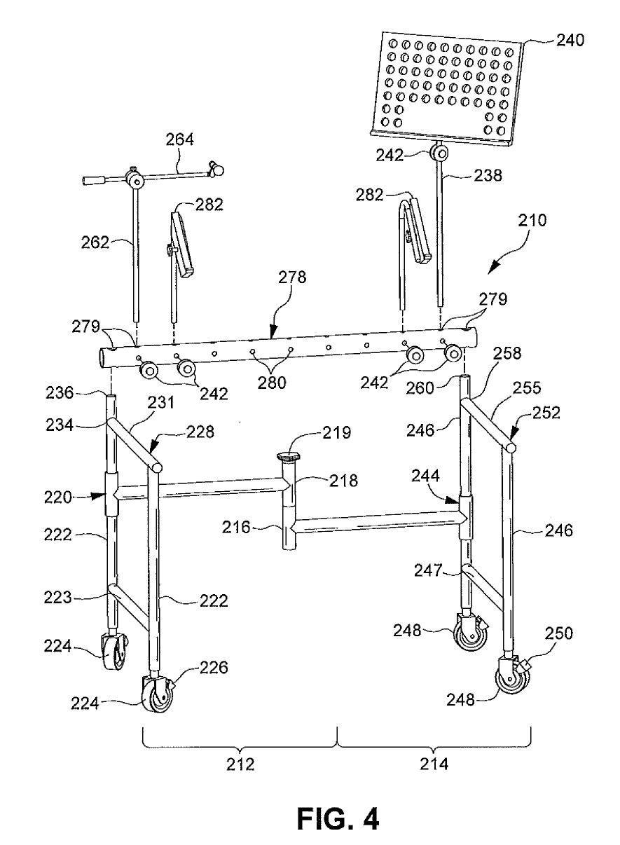

Referring to FIG. 4 of the drawings, there is shown an instrument stand 210. The stand 210 is adapted to support a musical instrument (not shown) such as a keyboard, for example. It is understood that the stand 210 may support other items as desired. In the embodiment shown, the stand 210 is formed from a metal such as aluminum. It is understood that other materials may be used to form the stand 210 without departing from the scope and spirit of the invention. The stand 210 includes a first section 212 hingedly coupled to a second section 214. In the embodiment shown, the second section 214 includes a male member 216 that is received by a corresponding hollow female member 218 of the first section 212. It is understood that the first section 212 can be hingedly coupled to the second section 214 by any means as desired. It is further understood that the male member 216 and the female member 218 may be securely coupled by a locking device 219. As shown, the locking device 219 is a rotatable threaded device adapted to selectively engage a portion of the male member 216 protruding from the female member 218, and thereby secure the male member 216 within the female member 218. Other locking devices such as locking pins may be used.

The first section 212 includes a first supporting structure 220 hingedly connected thereto. The first supporting structure 220 includes a pair of spaced apart first tubular members 222 and a support beam 223 disposed therebetween. As shown, the support beam 223 is coupled to each of the first tubular members 222 using a welding process. However, it is understood that any means for coupling the support beam 223 to the first tubular members may be used. It is further understood that the tubular members 222 and the support beam 223 may have any size and shape. Additionally, each of the first tubular members 222 includes a ground engaging wheel 224 pivotally disposed thereon. The wheels 224 each include locking structure 226 to selectably permit and militate against a rotation of the wheels 224.

A top portion 228 of the first supporting structure 220 includes a first instrument supporting shelf 231 thereon. It is understood that the first instrument supporting shelf 231 can be disposed elsewhere on the first supporting structure 220 as desired, such as at a position intermediate the wheels 224 and the top portion 228 thereof, for example.

A first end 234 of the first instrument supporting shelf 231 includes a second tubular member 236 extending therefrom. In the embodiment shown, one of the first tubular members 222 is formed integrally with the second tubular member 236. It is understood that the tubular members 222, 236 can be formed separately if desired. The second tubular member 236 is adapted to receive and support a utility cross bar 278. It is understood that the second tubular member 236 can receive other structures as desired without departing from the scope and spirit of the invention.

The second section 214 includes a second supporting structure 244 hingedly connected thereto. The second supporting structure 244 includes a pair of spaced apart fourth tubular members 246 and a support beam 247 disposed therebetween. As shown, the support beam 247 is coupled to each of the second tubular members 246 using a welding process. However, it is understood that any means for coupling the support beam 247 to the second tubular members 246 may be used. It is further understood that the tubular members 246 and the support beam 247 may have any size and shape. Additionally, each of the second tubular members 246 includes a wheel 248 pivotally disposed therein. The wheels 248 each include locking structure 250 to selectably permit and militate against a rotation of each of the wheels 248.

A top portion 252 of the second supporting structure 244 includes a second instrument supporting shelf 255 disposed thereon. It is understood that the second instrument supporting shelf 255 can be disposed elsewhere on the second supporting structure 244 as desired, such as at a position intermediate the wheels 248 and the top portion 252 thereof, for example.

A first end 258 of the second instrument supporting shelf 255 includes a fifth tubular member 260 extending therefrom. In the embodiment shown, one of the fourth tubular members 246 is formed integrally with the fifth tubular member 260. It is understood that the tubular members 246, 250 can be formed separately if desired. As shown, the fifth tubular member 260 is adapted to receive and support the utility cross bar 278, wherein the utility cross bar 278 extends along a length between the second tubular member 236 and the fifth tubular member 246. It is understood that the fifth tubular member 246 can receive other structures as desired without departing from the scope and spirit of the invention.

The utility cross bar 278 is disposed adjacent the instrument supporting shelves 231, 255. The utility cross bar 278 includes a plurality of first through-holes 279 and a plurality of second through-holes 280. As shown, the second tubular member 236 is disposed through one of the first through-holes 279 and the fifth tubular member 260 is disposed through another of the first through-holes 279 to integrate the utility cross bar 278 with the stand 210 and provide structural support to the utility cross bar 278. Each of the through holes 279, 280 may have any shape, size, and orientation relative to a longitudinal axis of the utility cross bar 278.

The first through-holes 279 are also adapted to receive a third tubular member 238 coupled to a bookstand 240. A plurality of threaded securing devices 242 are disposed in the second through holes 280 and apertures (not shown) formed in the third tubular member 238 to facilitate a selective positioning of the bookstand 240 or other accessory. Other securing devices such as locking pins may be used, for example. It is understood that the third tubular member 238 and the bookstand 240 can be removed from the stand 210. It is further understood that the first through-holes 279 can receive other structures without departing from the scope and spirit of the invention.

As a non-limiting example, the first through-holes 279 may receive a sixth tubular member 262 that is coupled to a microphone supporting device 264. The threaded securing devices 242 are disposed in the second through holes 280 and apertures (not shown) formed in the sixth tubular member 262 to facilitate selective positioning of the microphone supporting device 264 or other accessory. It is understood that the sixth tubular member 262 and the microphone supporting device 264 can be removed from the stand 210 if desired.

As a further example, the first through-holes 279 may receive a plurality of supplemental supporting shelves 282 for supporting a musical instrument such as a digital keyboard, for example. The threaded securing devices 242 are disposed in the second through holes 280 and apertures (not shown) formed in the supplemental supporting shelves 282 to facilitate selective positioning thereof. It is understood that the supplemental supporting shelves 282 can be removed from the stand 210 if desired. It is further understood that the supplemental supporting shelves may have any shape and size.

Use of the stand 210 is substantially the same as the stand 10 illustrated in FIGS. 1 and 2 and described above. However, when the stand 210 is in the set up position, as shown in FIG. 4, the utility cross bar 278 is mounted on the stand 210 by guiding the second tubular member 236 and the fifth tubular member 260 through the corresponding first through-holes 279 of the utility cross bar 278. Once mounted, various accessories such as the bookstand 240, the microphone supporting device 264, and the supplemental supporting shelves 282 may be secured to the utility cross bar 278.

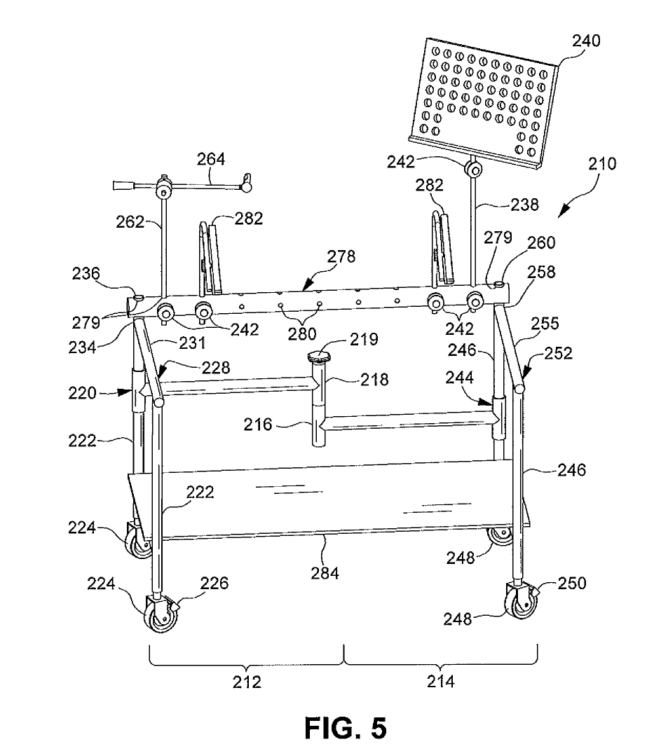

FIG. 5 shows the stand 210 including a removable storage shelf 284 according to another embodiment of the present invention. As a non-limiting example, the storage shelf 284 has a rectangular shape. However, any shape and size may be used. As shown, the storage shelf 184 is disposed on the supporting beam 223 of the first supporting structure 220 and the supporting beam 247 of the second supporting structure 244. The storage shelf 284 may be coupled to the supporting beams 223, 247 using any coupling means such as a threaded securing pin, a locking pin, and a clamp, for example. It is understood that in certain embodiments, the storage shelf 284 is simply supported on the supporting beams 223, 247.

In use, the storage shelf 284 is mounted to the stand 210 when the stand 210 is in the set up position. Once mounted, the storage shelf 284 provides addition storage, support, and stability to the stand 210.

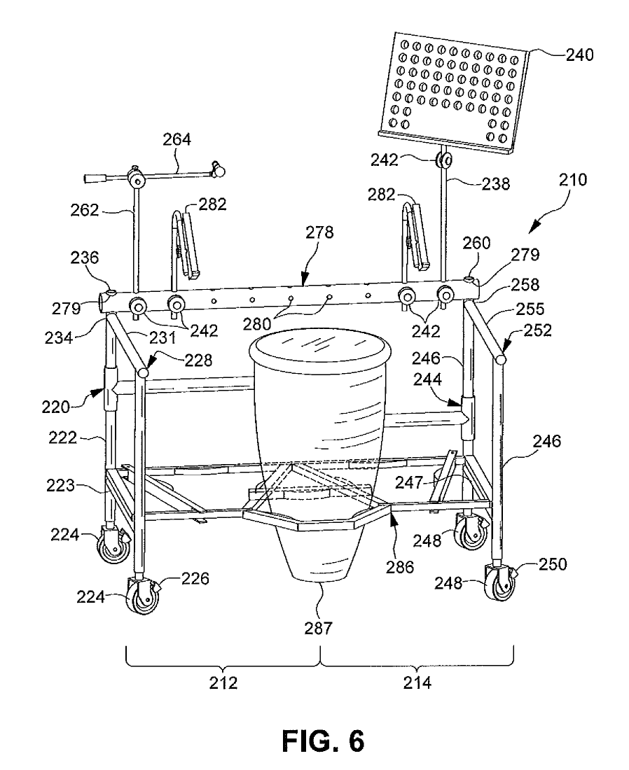

FIG. 6 shows the stand 210 including a removable equipment caddy 286 for securing and transporting a equipment according to another embodiment of the present invention. As a non-limiting example, the equipment caddy 286 is shown supporting a drum 287. However, it is understood that the equipment caddy 286 may be used to secure, support, and transport other equipment and objects.

The equipment caddy 286 is disposed on the on the supporting beam 223 of the first supporting structure 220 and the supporting beam 247 of the second supporting structure 244. The equipment caddy 286 may be coupled to the supporting beams 223, 247 using any coupling means such as a threaded securing pin, a locking pin, a channel, and a clamp, for example. It is understood that in certain embodiments, equipment caddy 286 is simply supported by the supporting beams 223, 247.

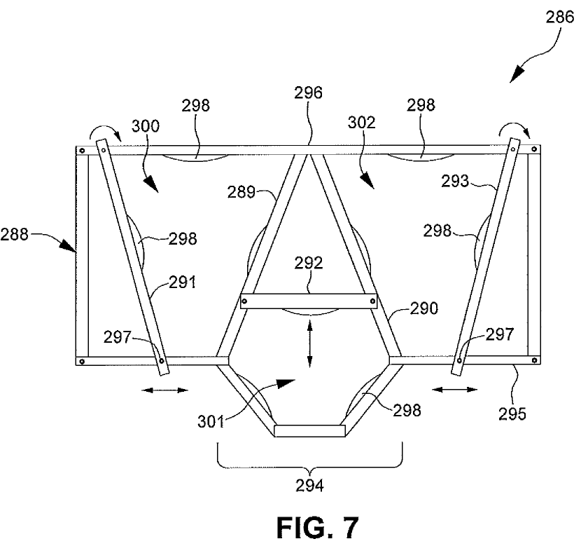

As more clearly shown in FIG. 7, the equipment caddy 286 includes a main frame 288, a plurality of static members 289, 290, and a plurality of moveable members 291, 292, 293. Specifically, the main frame 288 has a substantially rectangle shape with an arcuate section 294 formed in a first side 295. In the embodiment shown, a first static member 289 is coupled to the main frame 288 at the first side 295 and at a second side 296 of the main frame 288. A second static member 290 is coupled to the main frame 288 at the first side 295 and the second side 296, wherein the second static member 290 is angled away from the first static member 289. As a non-limiting example, the static members 289, 290 and the arcuate section 294 of the main frame 288 form a substantially diamond shape.

A first moveable member 291 is pivotally coupled to the second side 296 of the main frame 288 and slideably coupled to the first side 295 of the main frame 288. A second moveable member 292 is slideably coupled to each of the first static member 289 and the second static member 290. A third moveable member 293 is pivotally coupled to the second side 296 of the main frame 288 and slideably coupled to a first side 295 of the main frame 288. The moveable members 291, 292, 293 may be locked into a substantially static position using a locking feature 297 such as a threaded fastener, a locking pin, and a clamp, for example.

The equipment caddy 286 further includes a plurality of friction pads 298 disposed on the main frame 288, the static members 289, 290, and the moveable members 291, 292 for securing the drums 287 to the equipment caddy 286 and militating against a motion of the drums 287 relative to the equipment caddy 286. As a non-limiting example, the friction pads 298 are formed from a rubber. However, other materials with suitable coefficients of friction may be used. It is understood that the friction pads 298 may be coupled to any surface or portion member of the equipment caddy 286. It is further understood that more or fewer friction pads 298 may be used.

In use, the equipment caddy 286 is mounted to the stand 210 when the stand 210 is in the set up position. The moveable members of the equipment caddy 286 may be adjusted to provide a plurality of storage spaces 300, 301, 302 having adjustable size. For example, the first moveable member 291 is adjusted along a length of the first side 295 of the main frame 288 to modify a first storage space 300 defined by the second side 296 of the main frame 288, the first moveable member 291 and the first static member 289. As such, once a desired size of the first storage space 300 is created, the first moveable member 291 may be locked into position using the locking feature 297. The drum 287 having a suitable size is then disposed within the first storage space 300 and secured by the friction pads 298 to militate against movement of the drum 287 that may dislodge the drum 287 from the equipment caddy 286. Similarly, the second moveable member 292 is adjusted along a length of the static members 289, 290 to modify a second storage space 301 defined by the arcuate section 294 of the main frame 288 and the second moveable member 292. Likewise, the third moveable member 293 is adjusted along a length of the first side 295 of the main frame 288 to modify a third storage space 302 defined by the third moveable member 293, the second side 296 of the main frame 288 and the second static member 290. It is understood that any number of static members 289, 290 and moveable members 291, 292, 293 may be included. It is further understood that the equipment caddy 286 may have any shape and structure for supporting any number of drums or other similarly sized objects.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A collapsible stand for supporting an instrument comprising:
a first section including a first instrument supporting shelf;
a second section including a second instrument supporting shelf and hingedly coupled to the first section, wherein the first instrument supporting shelf and the second instrument supporting shelf cooperate to support a first instrument;
a utility cross bar coupled to the first instrument supporting shelf and the second instrument supporting shelf, wherein the utility cross bar includes a plurality of through holes for receiving and securing an accessory device to the utility cross bar.

2. The stand according to claim 1, wherein the accessory device is one of a bookstand, a microphone supporting device, and a supplemental supporting shelf.

3. The stand according to claim 1, wherein at least one of the first section and the second section is extensible to adjust a width of the stand.

4. The stand according to claim 1, wherein the first section includes a first supporting structure supporting the first instrument supporting shelf and the second section includes a second supporting structure supporting the second instrument supporting shelf.

5. The stand according to claim 4, wherein at least one of the first supporting structure and the second supporting structure is extensible to facilitate a height of the stand.

6. The stand according to claim 4, further comprising a removable storage shelf disposed on the first supporting structure and the second supporting structure.

7. The stand according to claim 4, further comprising a removable equipment caddy disposed on the first supporting structure and the second supporting structure.

8. The stand according to claim 7, wherein the removable equipment caddy includes a frame, a plurality of static members coupled to a portion of the frame, and a plurality of moveable members slideably coupled to at least one of the frame and the static members.

9. The stand according to claim 1, wherein the first section includes a pair of spaced apart wheels disposed thereon and the second section includes a pair of spaced apart wheels disposed thereon.

10. The stand according to claim 9, wherein at least one of the wheels includes a locking structure to selectively permit and militate against a rotation of the wheel.

11. A collapsible stand for supporting an instrument comprising:
a first section including a first supporting structure, the first supporting structure including a first instrument supporting shelf;
a second section hingedly coupled to the first section and including a second supporting structure, the second supporting structure including a second instrument supporting shelf, wherein the first instrument supporting shelf and the second instrument supporting shelf cooperate to support a first instrument; and
an equipment caddy disposed on the first supporting structure and the second supporting structure, wherein the equipment caddy is adjusted to secure and transport equipment of various sizes and shapes.

12. The stand according to claim 11, wherein the equipment caddy includes a frame, a plurality of static members coupled to a portion of the frame, and a plurality of moveable members slideably coupled to at least one of the frame and the static members.

13. The stand according to claim 12, wherein the moveable members of the equipment caddy are adjusted to secure a plurality of drums.

14. The stand according to claim 11, wherein the equipment caddy includes a plurality of friction pads.

15. The stand according to claim 11, wherein at least one of the first section and the second section is extensible to adjust a width of the stand.

16. The stand according to claim 11, wherein at least one of the first supporting structure and the second supporting structure is extensible to facilitate a height of the stand.

17. The stand according to claim 11, further comprising a utility cross bar coupled to the first instrument supporting shelf and the second instrument supporting shelf, wherein the utility cross bar includes a plurality of through holes for receiving and securing an accessory device to the utility cross bar.

18. The stand according to claim 11, wherein the first section includes a pair of spaced apart wheels disposed thereon and the second section includes a pair of spaced apart wheels disposed thereon, wherein at least one of the wheels includes a locking structure to selectively permit and militate against a rotation of the wheel.

19. A collapsible stand for supporting an instrument comprising:
a first section including a first supporting structure, the first supporting structure including a first instrument supporting shelf;
a second section hingedly coupled to the first section and including a second supporting structure, the second supporting structure including a second instrument supporting shelf, wherein the first instrument supporting shelf and the second instrument supporting shelf cooperate to support a first instrument; and
a removable storage shelf disposed on the first supporting structure and the second supporting structure.

20. The stand according to claim 19, further comprising a utility cross bar coupled to the first instrument supporting shelf and the second instrument supporting shelf, wherein the utility cross bar includes a plurality of through holes for receiving and securing an accessory device to the utility cross bar.
